(19) United States
(12) Patent Application Publication
(10) Pub. No.: US 2023/0242395 A1
(43) Pub. Date: Aug. 3, 2023

(54) Ammonia Cracking for Green Hydrogen

(71) Applicant: Air Products and Chemicals, Inc., Allentown, PA (US)

(72) Inventors: Andrew Shaw, Sunbury On Thames (GB); Vincent White, Ashtead (GB); Edward Landis Weist, Jr., Macungie, PA (US); Paul Higginbotham, Guildford (GB); Donald E Henry, Allentown, PA (US)

(73) Assignee: Air Products and Chemicals, Inc., Allentown, PA (US)

(21) Appl. No.: 18/010,971

(22) PCT Filed: Jun. 18, 2021
(86) PCT No.: PCT/US2021/038007

§ 371 Date: Dec. 16, 2022

Related U.S. Application Data
(60) Provisional application No. 63/040,707, filed on Jun. 18, 2020.

(51) Int. Cl. C01B 3/04; C01B 3/56; C01B 3/50; B01J 6/00; B01D 53/047; B01D 53/22; B01D 53/00

(52) U.S. Cl. CPC C01B 3/047; B01D 53/002; B01D 53/047; B01D 53/229; B01J 6/008; C01B 3/56; C01B 3/501; B01D 2256/16; B01D 2257/102; B01D 2257/406; C01B 2203/042; C01B 2203/84; C01B 2203/0405; C01B 2203/0465; C01B 2203/0833; C01B 2203/0883

(57) ABSTRACT

Recovery of hydrogen from an ammonia cracking process in which the cracked gas is purified in a PSA device is improved by using a membrane separator on the PSA tail gas.

### BACKGROUND

Global interest in renewable energy and using this renewable energy to generate green hydrogen has driven the interest in converting the green hydrogen to green ammonia, as ammonia is simpler to transport over distance of hundreds or thousands of miles. Particularly, shipping liquid hydrogen is not commercially possible currently but shipping ammonia, which is in a liquid state, is currently practiced.

For use in a commercial fuel cell, the ammonia must be converted back to hydrogen according to the reaction.

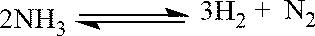

This is an endothermic process, i.e., a process that requires heat, and is performed over a catalyst. This process is known as cracking. The gas produced (or “cracked gas”) is a combination of hydrogen (H₂) and nitrogen (N₂). Since the cracking reaction is an equilibrium reaction, there is also some residual ammonia. In most applications of crackers currently, the hydrogen + nitrogen mixture is utilised as is. However, as ammonia can be a poison to fuel cells, this stream, with ammonia suitably removed such as by scrubbing with water, can be used directly in a fuel cell. However, if the hydrogen is to be used in vehicle fueling, the nitrogen present provides a penalty to the process. The fuel to a vehicle fueling system is compressed to significant pressure — up to 900 bar. This means that the nitrogen, which is merely a diluent in the process, is also compressed, taking power, and taking storage volume and increasing anode gas purge requirement, decreasing efficiency. It is therefore beneficial where hydrogen is to be used in vehicle fueling, for the hydrogen + nitrogen to be purified.

Small scale cracking reactors, or “crackers”, typically use pressure swing adsorption (“PSA”) devices to separate the cracked gas and recover the hydrogen and generate a PSA tail gas (or offgas). However, these crackers are generally heated electrically and the PSA tail gas is typically vented to atmosphere.

As is common in hydrogen production from a steam methane reforming (SMR) reactor, a PSA can be used to purify the nitrogen + hydrogen. The cracking reaction is performed in tubes packed with catalyst which are externally heated by a furnace (see GB1142941).

GB1142941 discloses a process for making town gas from ammonia. The ammonia is cracked and the cracked gas scrubbed with water to remove residual ammonia. The purified hydrogen/nitrogen mixture is then enriched with propane and/or butane vapor to produce the town gas for distribution.

US6835360A discloses an endothermic catalytic reaction apparatus for converting hydrocarbon feedstock and methanol to useful gases, such as hydrogen and carbon monoxide. The apparatus comprises a tubular endothermic catalytic reactor in combination with a radiant combustion chamber. The resultant cracked gas is used directly in a fuel cell after passing through a gas conditioning system.

GB977830A discloses a process for cracking ammonia to produce hydrogen. In this process, the hydrogen is separated from the nitrogen by passing the cracked gas through a bed of molecular sieves which adsorbs nitrogen. The nitrogen is then driven off the bed and may be stored in a holder.

JP5330802A discloses an ammonia cracking process in which the ammonia is contacted with an ammonia decomposition catalyst at a pressure of 10 kg/cm² (or about 9.8 bar) and a temperature of 300 to 700° C. Hydrogen is recovered from the cracked gas using a PSA device. The reference mentions that the desorbed nitrogen may be used to boost the upstream process but no details are provided.

US2007/178034A discloses a process in which a mixture of ammonia and hydrocarbon feedstock is passed through a fired steam reformer at 600° C. and 3.2 MPa (or about 32 bar) where it is converted into a synthesis gas containing about 70 vol. % hydrogen. The synthesis gas is enriched in hydrogen in a shift reaction, cooled and condensate removed. The resultant gas is fed to a PSA system to generate a purified hydrogen product having 99 vol. % hydrogen or more. The offgas from the PSA system is fed as fuel to the fired steam reformer.

CN111957270A discloses a process in which ammonia is cracked in a tubular reactor within a furnace. The cracked gas is separated by adsorption to produce hydrogen gas and a nitrogen-rich offgas. The fuel demand of the furnace appears to be satisfied using a combination of cracked gas, hydrogen product gas and/or offgas.

There is a need generally for improved processes for the production of hydrogen from ammonia and specifically for processes that are more efficient in terms of energy consumption and/or that have higher levels of hydrogen recovery and/or that reduce or eliminate the need to combust fossil fuels.

In the following discussion of embodiments of the present invention, the pressures given are absolute pressures unless otherwise stated.

### BRIEF SUMMARY OF THE INVENTION

According to a first aspect of the present invention, there is provided a method for producing hydrogen from ammonia, comprising:
pressurizing liquid ammonia;
heating (and optionally vaporizing) the liquid ammonia by heat exchange with one or more hot fluids to produce heated ammonia;
combusting a fuel in a furnace to heat catalyst-containing reactor tubes and to form a flue gas;
supplying the heated ammonia to the catalyst-containing reactor tubes to cause cracking of the ammonia into a cracked gas containing hydrogen gas and nitrogen gas;
purifying the cracked gas in a PSA device to produce a hydrogen product gas and a PSA tail gas; and
separating the PSA tail gas, or a gas derived therefrom, using a membrane separator to discharge a nitrogen-rich retentate gas and recycle a hydrogen-rich permeate gas for further processing in the PSA device and/or for mixing into the hydrogen product gas,
   wherein the fuel comprises one or more of ammonia, the PSA tail gas, hydrogen and methane; and
   wherein the one or more hot fluids comprise the flue gas and/or the cracked gas.

The liquid ammonia is typically pressurized to a pressure that is greater than 1.1 bar, e.g. at least 5 bar or at least 10 bar. In some embodiments, the liquid ammonia is pressurized to a pressure in a range from about 5 bar to about 50 bar, or in a range from about 10 to about 45 bar, or in a range from about 30 bar to about 40 bar.

The liquid ammonia is typically heated to produce heated ammonia at a temperature greater than about 250° C., e.g. in a range from about 350° C. to about 800° C., or from about 400° C. to about 600° C. At the pressures in question, the liquid ammonia is typically vaporized completely to form heated ammonia vapour.

The temperature is ultimately determined by the identity of the catalyst, the operating pressure and the desired “slip”, i.e. the amount of ammonia that passes through the cracking reactor without being cracked. In this regard, the process is typically operated with no more than about 4% slip which would be the amount of slip if the cracking process were operated 5 bar and 350° C. with a close approach to equilibrium. Problems may arise with some construction materials at any appreciable pressure at temperatures above about 700° C.

The cracking reaction takes place in catalyst-filled reactor tubes that are heated by a furnace. However, in theory any heterogeneously catalysed gas reactor could potentially be used for the conversion.

There are a large number of catalysts known in the art as useful for the ammonia cracking reaction and any of these conventional catalysts may be used in this invention.

The primary fuel for the furnace typically comprises methane. The fuel may be pure methane but is more likely natural gas or biogas. In some embodiments, the primary fuel is natural gas or biogas which is supplemented with hydrogen as a secondary fuel, optionally in the form of an ammonia cracked gas. In these embodiments, liquid ammonia may be pumped and cracked to form the cracked gas which is added to the primary fuel.

The PSA device may operate a PSA cycle or a vacuum swing adsorption (VSA) cycle. A TSA device may be used in combination with the PSA device, the TSA device to remove ammonia (see US10787367) and the PSA device to remove nitrogen and produce the hydrogen product. Suitable PSA cycles include any of the cycles disclosed in US9381460, US6379431 and US8778051.

Recycling the hydrogen-rich permeate gas for further processing in the PSA device (or, for simplicity, the “PSA”) improves hydrogen recovery significantly and recovery rates may approach 100%, e.g. may be about 99%.

Like hydrogen, ammonia is a “fast gas” that readily permeates across membranes used for gas separation. Some membranes, such as those constructed of polyamide or polysulfone polymers, are more tolerant of ammonia. However, some membranes, such as those constructed of polyimide polymers, are less tolerant of ammonia. Therefore, ammonia is typically removed, or its concentration is at least reduced, upstream of the membrane separator.

Ammonia removal may be achieved in several different locations within the process. Prior to separating the PSA tail gas, ammonia may be removed from the PSA tail gas. Alternatively, prior to purifying the cracked gas, ammonia may be removed from the cracked gas. In both cases, the removed ammonia may be recovered and recycled into the ammonia supplied to the catalyst-containing reactor tubes.

Ammonia may be removed from a gas by adsorption (e.g. by TSA) or by absorption in water, e.g. by washing the gas with water in a scrubber column. The resultant ammonia-depleted gas and ammonia solution are separated so the ammonia-depleted gas can be further processed without the ammonia causing any difficulties. Ammonia can be recovered from the ammonia solution by stripping in a distillation column system. Such a process may be applied to the cracked gas prior to being supplied to the PSA unit or alternatively to the PSA tail gas prior to being supplied to the membrane separator.

In some preferred embodiments, however, ammonia is condensed out of the PSA tail gas and the condensed ammonia is fed to the ammonia feed to the cracker. In these embodiments, the process comprises:
compressing the PSA tail gas to produce compressed PSA tail gas;
cooling the compressed PSA tail gas by heat exchange against one or more cold fluids to condense ammonia in the compressed PSA tail gas; and
separating the condensed ammonia from the compressed PSA tail gas to produce ammonia-depleted PSA tail gas,
wherein the ammonia-depleted PSA tail gas is supplied as the feed to the membrane separator.

The one or more cold fluids may comprise an external refrigerant although, in preferred embodiments, the one or more cold fluids comprise the pressurized liquid ammonia and/or the ammonia-depleted PSA tail gas for internal heat integration of the process.

The condensed ammonia may be rejected from the process but is preferably combined with the pressurized liquid ammonia.

The membrane separator may comprise only a single membrane separation unit (also referred to as a membrane stage). In these embodiments, the membrane separator does not comprise more than one membrane separation unit. In preferred embodiments, however, the membrane separator comprises a first membrane separation unit and a second membrane separation unit in series. In these embodiments, the method further comprising:
supplying the ammonia-depleted PSA tail gas to the first membrane separation unit to produce the hydrogen-rich permeate gas for further processing in the PSA and a nitrogen-enriched retentate gas comprising residual hydrogen; and
supplying the nitrogen-enriched retentate gas to the second membrane separation unit to discharge the nitrogen-rich retentate gas and produce a further hydrogen-rich permeate gas which is combined with the PSA tail gas.

Using two membrane separation units in this way helps avoid having to use a second compressor for compressing the hydrogen being recycled to the PSA and therefore uses less power overall than involving two compressors while maintaining high hydrogen recovery rates (-99%).

The nitrogen-rich retentate gas may be expanded in a turbine to recover power prior to being vented to the atmosphere after suitable treatment to remove contaminants such as ammonia. In such embodiments, the nitrogen-rich retentate gas is typically heated by heat exchange with the one or more hot fluids prior to expansion. Alternatively, the nitrogen-rich retentate gas may be purified to produce a nitrogen product.

According to a second aspect of the present invention, there is provided apparatus for producing hydrogen from ammonia, comprising:
a pump for pressurizing liquid ammonia;
at least one first heat exchanger in fluid communication with the pump for heating (and optionally vaporizing) the liquid ammonia from the pump by heat exchange with one or more hot fluids;
catalyst-containing reactor tubes in fluid communication with the first heat exchanger(s), for cracking heated ammonia from the first heat exchanger(s) to produce a first cracked gas containing hydrogen gas and nitrogen gas;
a furnace in thermal communication with the catalyst-containing reactor tubes for combustion of a fuel to heat the catalyst-containing reactor tubes and to form a flue gas;
a PSA device in fluid communication with the catalyst-containing reactor tubes for purifying the cracked gas to produce a hydrogen product gas and a PSA tail gas;
a membrane separator in fluid communication with the PSA device for separating the PSA offgas, or a gas derived therefrom, to discharge a nitrogen-rich retentate gas and a hydrogen-rich permeate gas;
wherein the apparatus comprises a conduit for feeding the hydrogen-rich gas to the PSA device for further processing and/or a conduit for combining hydrogen-rich gas with the first hydrogen product gas.

The furnace may be separate from the catalyst-filled reactor tubes although the furnace and the catalyst-filled reactor tubes are preferably integrated within the same unit. In preferred embodiments, a steam methane reforming (SMR) type reactor is used in which the furnace comprises a radiant section through which pass the catalyst-containing reactor tubes.

The apparatus typically comprises an ammonia removal system upstream of the membrane separator in order to protect ammonia intolerant membranes and/or to prevent ammonia from passing through the membranes with the hydrogen. The ammonia removal system may be a scrubbing column for removing the ammonia by absorption in water, or may be a TSA device for removing the ammonia by adsorption.

The ammonia removal system may be located downstream of the PSA device and so removes ammonia from the PSA tail gas. Alternatively, the ammonia removal system may be located downstream of the at least one heat exchange and upstream of the PSA device and so removes ammonia from the cracked gas.

The apparatus may also comprise an ammonia recovery system for recovering ammonia gas from the aqueous ammonia solution produced in the scrubbing column. The recovery system may comprise a stripping column (or a stripping section in a distillation column system) for recovering ammonia from the aqueous ammonia solution.

Additionally or alternatively, the apparatus may comprise a selective catalytic reduction (SCR) reactor for removing oxides of nitrogen from the flue gas to which at least part of the aqueous ammonia solution is fed to provide ammonia for the SCR reaction.

A PSA tail gas compressor is typically provided downstream of the PSA device for compressing the PSA tail gas for the membrane separator. The compressor may consist of one or more stages and cooling will take place between each stage and after the final stage. Water will typically condense out of the compressed PSA tail gas at the interstages or at the aftercooler stage. The aqueous condensate is typically removed after each cooling stage of the compressor and a small amount of ammonia will come out of the PSA tail gas with this condensate.

Additionally or alternatively, a hydrogen-rich gas compressor is typically downstream of the membrane separator for compressing the hydrogen-rich gas for the PSA device and/or for combining with the hydrogen product gas.

In some preferred embodiments, the apparatus comprises:
a PSA tail gas compressor in fluid communication with the PSA device for compressing PSA tail gas;
a heat exchanger in fluid communication with the PSA tail gas compressor for cooling compressed PSA tail gas by heat exchange against one or more cold fluids;
a phase separator in fluid communication with the heat exchanger for separating condensed ammonia from cooled compressed PSA tail gas to form ammonia-depleted PSA tail gas; and
a conduit for supplying ammonia-depleted PSA tail gas from the phase separator to the membrane separator.

In these embodiments, the apparatus may comprise a conduit for supplying the condensed ammonia to the pressurized liquid ammonia.

In addition, where the membrane separator comprises a first membrane separation unit and a second separation unit in series, the apparatus may further comprise:
a conduit for supplying ammonia-depleted PSA tail gas from the phase separator to the first membrane separation unit;
a conduit for supplying the hydrogen-rich permeate gas from the first membrane separation unit to the PSA device for further processing;
a conduit for supplying a nitrogen-enriched retentate gas from the first membrane separation unit to the second membrane separation unit; and
a conduit for supplying an additional hydrogen-rich permeate gas from the second membrane unit to the PSA off gas.

The apparatus typically comprises a conduit for supplying nitrogen-rich retentate gas from the membrane separator to a vent, optionally together with a turbine located downstream of the membrane separator for expanding nitrogen-rich retentate gas and recovering power. In addition, a heat exchanger may be located upstream of the turbine for heating nitrogen-rich retentate gas by heat exchange with one or more hot fluids.

Alternatively, a nitrogen purification device may be in fluid communication with the membrane separator for purifying nitrogen-rich retentate gas to produce nitrogen gas product.

### BRIEF DESCRIPTION OF THE DRAWINGS

FIG. 1 is a process flow diagram of a first reference example of an ammonia cracking process to produce hydrogen;

FIG. 2 is a process flow diagram of another reference example based on the ammonia cracking process of FIG. 1 in which no hydrogen product is used as fuel

FIG. 3 is a process flow diagram of a further reference example based on the ammonia cracking process of FIGS. 1 & 2 in which only PSA tail gas is used as fuel;

FIG. 4 is a process flow diagram of a first embodiment of an ammonia cracking process to produce hydrogen according to the present invention;

FIG. 5 is a process flow diagram of a second embodiment of an ammonia cracking process to produce hydrogen according to the present invention;

FIG. 6 is a process flow diagram of a third embodiment of an ammonia cracking process to produce hydrogen according to the present invention;

FIG. 7 is a table showing results of the process depicted in FIG. 2;

FIG. 8 is a table showing results of the process depicted in FIG. 3;

FIG. 9 is a table showing results of the process depicted in FIG. 4; and

FIG. 10 is a table showing results of the process depicted in FIG. 5.

### DETAILED DESCRIPTION OF THE INVENTION

A process is described herein for producing hydrogen by cracking ammonia. The process has particular application to producing so-called “green” hydrogen which is hydrogen created using renewable energy instead of fossil fuels. In this case, the ammonia is typically produced by electrolyzing water using electricity generated from renewable energy, such as wind and/or solar energy, to produce hydrogen which is then reacted catalytically with nitrogen (Haber process) to produce the ammonia which is more easily transported than hydrogen. After reaching its destination, the ammonia is then cracked to regenerate the hydrogen.

In this inventive process, the heat required for the reaction is typically provided by combustion of PSA tail gas (which usually contains some amount of residual hydrogen and ammonia) in the furnace. If the PSA tail-gas has insufficient heating value than either vaporised ammonia, a portion of the product hydrogen, or an alternative fuel may be used with the tail-gas as a trim fuel.

In practice, natural gas could be used as a trim fuel, together with the PSA tail gas, as is practiced in SMRs for hydrogen. However, with the desire to maintain the “green” or renewable credentials of the hydrogen so produced, there is an incentive to use a “renewable fuel”. This can be the cracked “renewable” ammonia, the ammonia itself, or another renewable energy source, such as biogas, or indeed electric heating whether the electricity is itself from a renewable source, in this case local to the cracking process as opposed to the renewable electricity used to generate the hydrogen which has been transported in the form of ammonia.

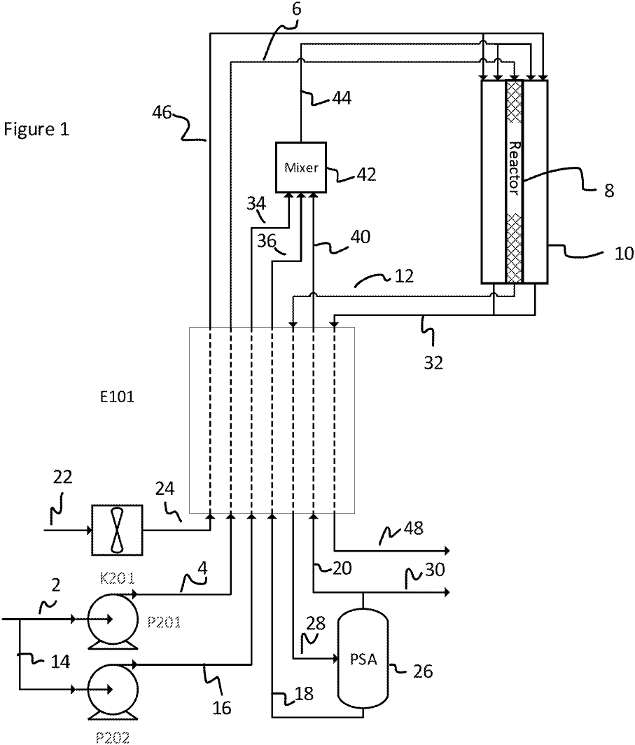

A reference example of the process is shown in FIG. 1. The process takes liquid ammonia from storage (not shown). The ammonia to be cracked (line 2) is pumped (pump P201) as liquid to a pressure greater than the desired cracking pressure (see GB1142941). The reaction pressure is a compromise between operating pressure and conversion according to Le Chatelier’s principle. There is an incentive to operate the reactor (8) at higher pressure because pumping liquid ammonia requires less power and capital than compressing the product hydrogen.

The pressurised liquid ammonia (line 4) is then heated, vaporised (if it is below its critical pressure) and heated further, up to a temperature of greater than 250° C. via a heat exchanger (E101) using the heat available in the cracked gas leaving the reaction tubes and the flue gas from the furnace. In the figure, the heat exchanger (E101) is shown as one heat exchanger but, in practice, it will be a series of heat exchangers in a network.

The initial heating and vaporization of the pressurized liquid ammonia may alternatively take place against an alternative heat source, such as cooling water or ambient air. Typical reaction temperatures are greater than 500° C. (see US2601221), palladium-based systems can run at 600° C. and 10 bar, whereas RenCat’s metal oxide-based system runs at less than 300° C. and 1 bar. (See https://www.ammoniaenergy.org/articles/ammonia-craking-to-high-purity-hydrogen-for-pem-fuel-cells-in-denmark/). The operating pressure of the cracker is typically an optimization of several factors. Cracking of ammonia into hydrogen and nitrogen is favored by low pressure but other factors favor higher pressure, such as power consumption (which is minimized by pumping the feed ammonia rather than compressing the product hydrogen), and the PSA size (which is smaller at higher pressure).

The hot ammonia (line 6) enters reaction tubes of a reactor (8) at the desired pressure where additional heat is provided by the furnace (10) to crack the ammonia into nitrogen and hydrogen. The resulting mixture of residual ammonia, hydrogen and nitrogen exits (line 12) the reaction tubes of the reactor (8) at the reaction temperature and pressure. The reaction products are cooled in a heat exchanger (E101) against a combination of feed ammonia (from line 4), furnace fuel (in this case pumped ammonia from line 14, pump P202 and line 16; PSA tail gas from line 18; and product hydrogen to be used as fuel in line 20) and combustion air (from line 22, fan K201 and line 24) to reduce the temperature as close as possible to that required for the inlet of a PSA device (26). Any residual heat in the cracked gas mixture (line 28) is removed in a water cooler (not shown) to achieve an inlet temperature to the PSA device (26) of in a range from about 20° C. to about 60° C., e.g. about 50° C.

The PSA product (line 30) is pure hydrogen compliant with ISO standard 14687 - Hydrogen Fuel Quality - with residual ammonia < 0.1 ppmv and nitrogen < 300 ppmv - at approximately the reaction pressure. The product hydrogen (line 30) is further compressed (not shown) for filling into tube trailers (not shown) for transport or it may be liquefied in a hydrogen liquefier (not shown) after any required compression. The PSA tail gas (line 18) or “purge gas” from the PSA device (26) is shown as being heated via the heat exchanger E101, using the cracked gas (line 12) leaving the reaction tubes of the reactor (8) or furnace flue gas (line 32), before being sent (in line 36) to the furnace as a combustion fuel. However, the PSA tail gas (line 18) may be fed directly to the furnace (10) without heating.

The resultant warmed ammonia fuel (line 34) and warmed hydrogen (line 40) are depicted as combined with the (optionally) warmed PSA tail gas (line 36) in a mixer (42) to produce a combined fuel which is fed (line 44) to the furnace (10) for combustion to generate the flue gas (line 32 and, after cooling in E101, line 48). However, it should be noted that one or more of the fuels could be fed directly to the furnace without prior mixing. The warmed air (for combustion of the fuel) is fed to the furnace (10) in line 46.

One of the aims of preferred embodiments of the present process is to maximise the amount of hydrogen generated by cracking the renewable ammonia. That means minimising the amount of hydrogen used as fuel, or ammonia if ammonia were to be used as a fuel directly. Therefore, heat integration is important so as to use the hot flue gas and cracked gas appropriately, for instance to preheat air (line 24) and ammonia (line 4) to the cracker as this reduces the amount of “fuel” to be used in the burners of the furnace (10). This leads to higher hydrogen recovery as less of the hydrogen is lost in the furnace flue gas (lines 32 & 48) as water. Therefore, steam generation, for instance, should be minimised in favour of intra-process heat integration.

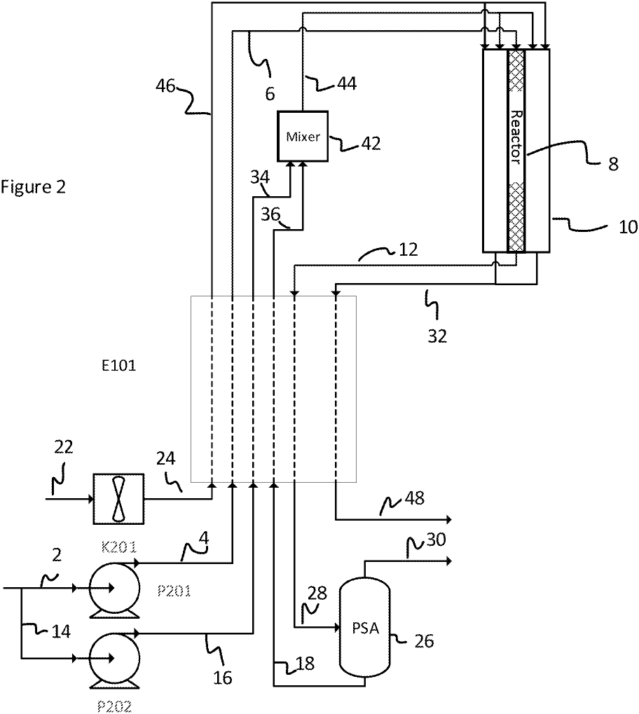

FIG. 1 shows ammonia provided as fuel (lines 34 & 44) and feed (line 6) and it also shows product hydrogen as fuel (lines 40 & 44) - in practice, it is likely only one of these streams would be used as fuel. In this regard, FIG. 2 depicts a similar process to that of FIG. 1 in which ammonia is used as a fuel (line 34) but not product hydrogen. All other features of the process depicted in FIG. 2 are the same as in FIG. 1 and the common features have been given the same reference numerals.

The inventors are aware that stable combustion of ammonia is facilitated if hydrogen is also used as a fuel, particularly at start-up and warm-up.

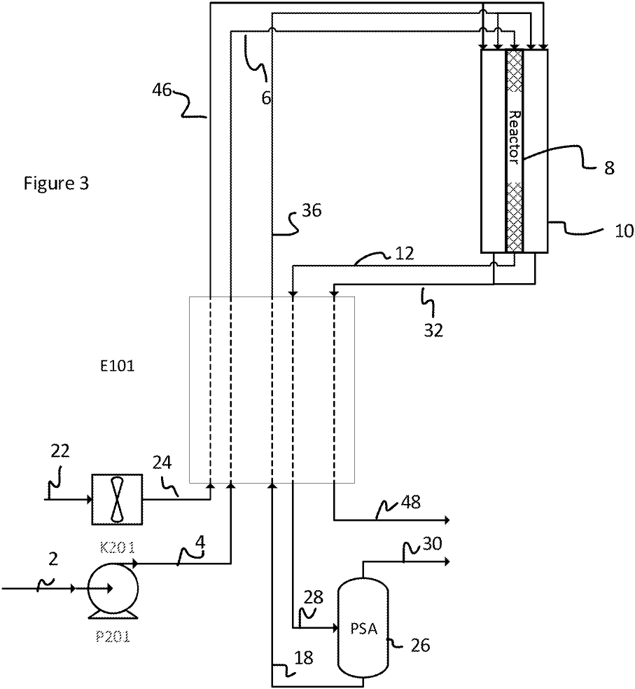

FIG. 3 depicts a process similar to that depicted in FIG. 2. In this process, the recovery of hydrogen (line 30) from the PSA may be adjusted to provide a tail gas (line 18) which, when burned, will provide all the heat required by the process, thus eliminating the need for a trim fuel. All other features of the process depicted in FIG. 3 are the same as in FIG. 1 and the common features have been given the same reference numerals.

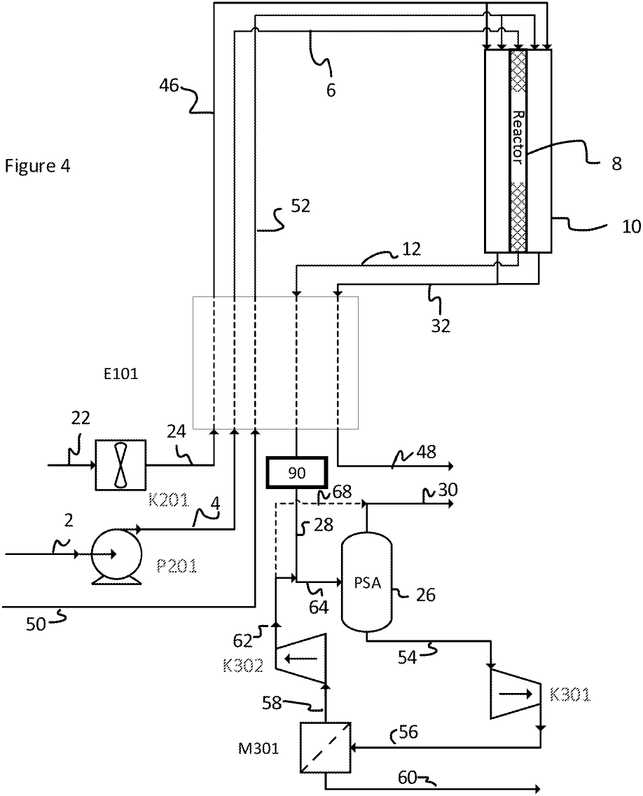

Should there be a viable alternative source of renewable energy for the cracking reactions, as discussed above, one could consider recovering hydrogen from the PSA tail gas to increase the net hydrogen production from the process in addition to the hydrogen produced from the PSA. Such a process could use membranes, which have a selective layer that is readily permeable to hydrogen but relatively impermeable to nitrogen, to separate hydrogen from the nitrogen rich PSA tail gas stream (FIG. 4).

Ammonia may need to be removed particularly but not exclusively if membranes are being used as part of the separation process since membrane material can be intolerant of high concentrations of ammonia and ammonia is a fast gas and would permeate with the hydrogen so would accumulate in the process if not removed. Ammonia may be removed for instance by a water wash or other well-known technology for ammonia removal, upstream of the membrane. Ammonia may be recovered from an aqueous ammonia solution generated in the water wash using a stripping column and the recovered ammonia could be recycled to the feed to the cracking reactor. This could theoretically increase the hydrogen recovery from the process up to 100%. Recovering ammonia from the cracked gas simplifies the hydrogen purification steps, may increase the recovery of hydrogen from the ammonia if the separated ammonia is recovered as feed, and also removes ammonia from the feed to the burners, eliminating concerns over production of NOₓ caused by burning ammonia.

Water may also need to be removed from the feed ammonia to prevent damage to the ammonia cracking catalyst. Typically ammonia has small quantities of water added to it to prevent stress corrosion cracking in vessels during shipping and storage. This might need to be removed. However, the water removal can be incorporated into the stripping column mentioned above. The ammonia would be evaporated at the required pressure, taking care in the design of the evaporator to ensure that the water was also carried through to the stripping column with the evaporator ammonia. This mostly vapor phase ammonia enters a mid-point of the column and pure ammonia leaves through the top of the column. The column has a partial condenser (condenses only enough liquid for the reflux) and the overhead vapor contains the feed ammonia (free of water) plus the ammonia recovered from the cracker gas stream.

It may be more energy efficient to feed the cracked gas first to a membrane to produce a hydrogen-enriched permeate stream and a nitrogen-rich retentate stream that could be vented. The hydrogen-enriched permeate can be further purified in the PSA. A second membrane could be added to the PSA tail gas stream to further boost the overall hydrogen recovery. This configuration would greatly reduce the tail-gas compressor size.

The use of a membrane separator to increase hydrogen recovery allows the nitrogen to be vented from the process without passing through the combustion section of the process. In processes where the nitrogen stream is at pressure, it would be beneficial to expand the nitrogen to atmospheric pressure before venting to recover power through an expansion turbine. It would increase the amount of power recovered if the pressurized nitrogen were to be heated before expansion using heat available in the flue gas or cracked gas stream.

FIG. 4 depicts a process involving a membrane for recovering hydrogen from the PSA tail gas while eliminating nitrogen. The features of the process in FIG. 4 that are common to the processes of FIGS. 1 to 3 have been given the same reference numerals. The following is a discussion of the new features in FIG. 4.

A renewable fuel source (line 50) is warmed in the heat exchange (E101) and fed (line 52) to the furnace (10) for combustion to heat the catalyst-filled tubes of the cracking reactor (8).

The cooled cracked gas (line 28) is combined with compressed hydrogen-rich permeate gas (line 62) to form a combined gas which is fed (line 64) to the PSA device (26). The combined gas is separated to form the hydrogen product (line 30). The tail gas (line 54) from the PSA is compressed in a first compressor (K301) and the compressed gas is fed (line 56) to a membrane separation unit (M301) to produce an enriched hydrogen permeate stream (line 58) and a nitrogen-rich retentate stream (line 60). The membrane separation unit can consist of multiple membrane devices arranged in parallel or series as determined by the feed flow and desired hydrogen recovery. The permeate stream is compressed in a second compressor (K302) to form the compressed hydrogen-rich gas (line 62) which is recycled (line 64) to the PSA (26) with the cooled cracked gas (line 28) to increase overall rate of recovery of hydrogen.

Assuming the purity of the hydrogen produced by the membrane is sufficiently high, part (line 68) of the hydrogen permeate gas may be combined after compression with the hydrogen product (line 30), with the remainder being recycled (line 64) to the PSA with the cooled cracked gas (line 28). Combining part of the hydrogen permeate gas with the hydrogen product in this way would reduce the required size of the PSA and the power of K301 and K302.

Alternatively, all of the compressed hydrogen-rich permeate gas (line 62) may be combined with the hydrogen product (line 30) with none being recycled to the PSA (26).

FIG. 4 has a system (depicted as unit 90) for remove and recovering ammonia from the cracked gas. This system may involve a scrubbing column for removing the ammonia from the gas with water and a stripping column (or a stripping section in a distillation column system) for recovering ammonia from the water, or may involve a TSA device for removing ammonia by adsorption (see US10787367).

However, ammonia can also be condensed out of the compressed PSA off gas stream using the cold feed ammonia - that is shown in FIG. 5. The features of the process in FIG. 5 that are common to the processes of FIGS. 1 to 4 have been given the same reference numerals. The following is a discussion of the new features in FIG. 5.

In FIG. 5, the PSA tail gas (line 54) is compressed in a compressor (K301) and most of the water present in the PSA tail gas will leave as condensate in separator(s) of the intercooler and/or aftercooler (not shown) of the compressor (K301). The tail gas the compressed gas (line 70) is cooled by heat exchange in a heat exchanger (E102) to condense ammonia and any residual water out of the compressed gas. The cooled gas (line 72) is fed to a phase separator (74) to remove the condensate. The ammonia-depleted gas (line 76) is warmed by heat exchange against the compressed gas in the heat exchanger (E102) and the warmed gas is supplied (line 80) to the membrane separation unit (M301). The ammonia condensate is combined (line 78) with the cold feed ammonia (line 4) which is also warmed by heat exchange against the compressed gas in the heat exchanger (E102).

Ammonia usually passes through the membrane with recycled hydrogen so the low temperature separator is a way of removing and recycling ammonia to the feed stream. This process also produces a purge stream (line 60) that may be around 98% nitrogen. Should this stream contain residual ammonia, then it would need to be treated before it can be vented. However, the purge stream is at pressure and could be purified to produce a product nitrogen stream.

Overall, the process depicted in FIG. 5 typically results in a very high rate of recovery (~99%) of hydrogen from ammonia but does involve more compression power than other possible cycles.

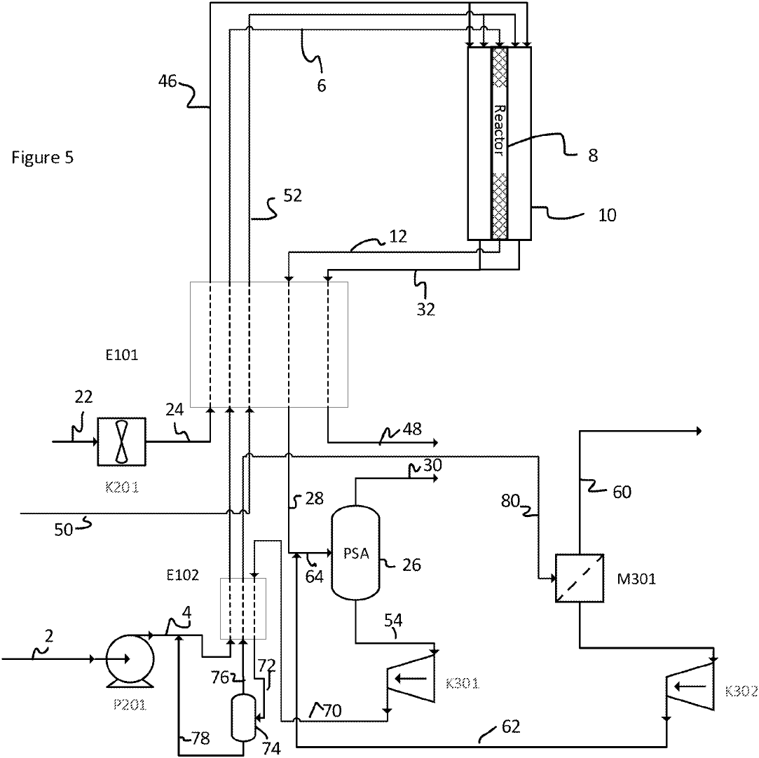

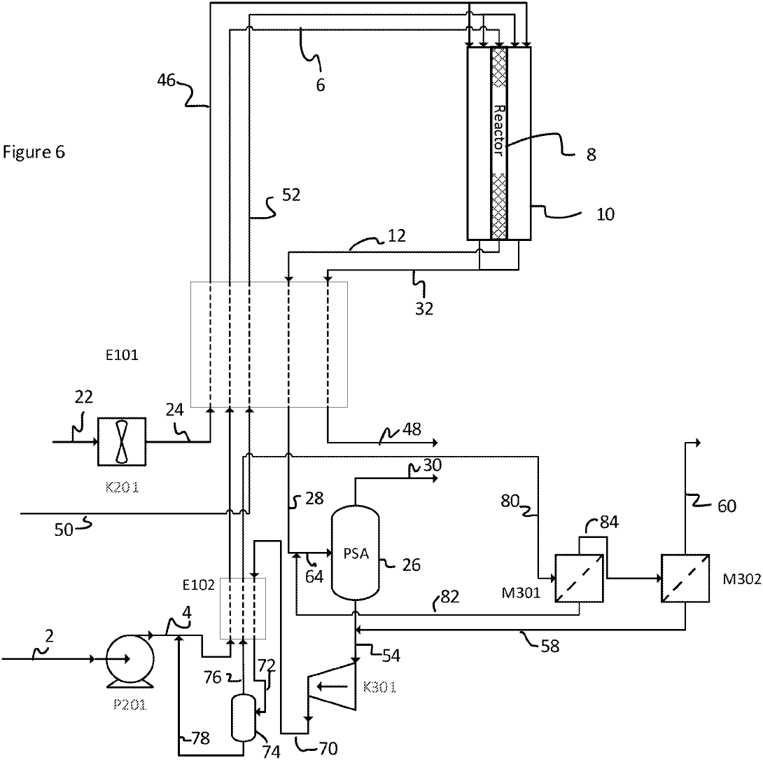

FIG. 6 is another configuration involving membranes. The features of the process in FIG. 6 that are common to the processes of FIGS. 1 to 5 have been given the same reference numerals. The following is a discussion of the new features in FIG. 6.

In FIG. 6, the warmed ammonia-depleted gas is supplied (line 80) to a first membrane separation unit (M301) to recover a hydrogen-enriched permeate gas that is combined (line 82) — without compression — to the feed (line 28) to the PSA device (26). The nitrogen-enriched retentate gas, which contains residual hydrogen, is fed (line 84) from the first membrane separator (M301) to a second membrane separation unit (M302) to recover a hydrogen-rich permeate gas (line 58) which is combined with the PSA tail gas (line 54) and compressed in the compressor (K301). The nitrogen-rich retentate gas (line 60) leaves the second membrane separation unit (M302) and is vented or purified. If there are combustible components in the nitrogen-rich retentate gas, then the gas may be used as fuel or flared.

The power requirement in FIG. 6 is typically lower than in FIG. 5 as the process requires only a PSA tail gas compressor whereas the process in FIG. 5 also requires a membrane compressor. However, hydrogen recovery in the process of FIG. 6 is still very high, e.g. -99%.

The present invention is not to be limited in scope by the specific aspects or embodiments disclosed in the examples which are intended as illustrations of a few aspects of the invention and any embodiments that are functionally equivalent are within the scope of this invention. Various modifications of the invention in addition to those shown and described herein will become apparent to those skilled in the art and are intended to fall within the scope of the appended claims.

The invention will now be illustrated with reference to the following Invention Examples and by comparison with the following Reference Examples. For the purposes of the simulations, both the Invention Examples and the Reference Examples assume an equilibrium for the cracking reaction at 11 bar and 500° C.

### Reference Example 1

The process depicted in FIG. 2 has been simulated by computer (Aspen Plus, ver. 10, Aspen Technology, Inc.) and the results are depicted in the table provided as FIG. 7.

In this Reference Example, hydrogen recovery from the ammonia is 77.18% with the PSA recovery at 83.5%. The total power of the ammonia feed pump (P201), the ammonia fuel pump (P202) and the air fan (K201) is about 1.36 kW.

### Reference Example 2

The process depicted in FIG. 3 has been simulated by computer (Aspen Plus, ver. 10) and the results are depicted in the table provided as FIG. 8.

In this Reference Example, hydrogen recovery from the ammonia is 77.05% with the PSA recovery at 79.4%. The total power of the ammonia feed pump (P201) and the air fan (K201) is about 1.37 kW.

### Invention Example 1

The process depicted in FIG. 5 has been simulated by computer (Aspen Plus, ver. 10) and the results are depicted in the table provided as FIG. 9.

In this Invention Example, hydrogen recovery from the ammonia is 98.95%. In addition, the total compression power requirement (PSA off gas compressor and membrane compressor) is about 60.59 kW.

### Invention Example 2

The process depicted in FIG. 6 has been simulated by computer (Aspen Plus, ver. 10) and the results are depicted in the table provided as FIG. 10.

In this Invention Example, hydrogen recovery from the ammonia is 98.95%. In addition, the total compression power requirement (PSA off gas compressor alone) is about 56.54 kW.

1. A method for producing hydrogen from ammonia, comprising:
pressurizing liquid ammonia;
heating (and optionally vaporizing) the liquid ammonia by heat exchange with one or more hot fluids to produce heated ammonia;
combusting a fuel in a furnace to heat catalyst-containing reactor tubes and to form a flue gas;
supplying the heated ammonia to the catalyst-containing reactor tubes to cause cracking of the ammonia into a cracked gas containing hydrogen gas and nitrogen gas;
purifying the cracked gas in a PSA device to produce a hydrogen product gas and a PSA tail gas; and
separating the PSA tail gas, or a gas derived therefrom, using a membrane separator to discharge a nitrogen-rich retentate gas and recycle a hydrogen-rich permeate gas for further processing in the PSA and/or for mixing into the hydrogen product gas,
wherein the fuel comprises one or more of ammonia, the PSA tail gas, hydrogen and methane; and
wherein the one or more hot fluids comprise the flue gas and/or the cracked gas.

2. A method according to claim 1, wherein ammonia is removed upstream of the membrane separator.

3. A method according to claim 1 comprising, prior to separating the PSA tail gas, recovering ammonia from the PSA tail gas and recycling the recovered ammonia into the ammonia supplied to the catalyst-containing reactor tubes.

4. A method according to claim 1 comprising, prior to purifying the cracked gas, recovering ammonia from the cracked gas and recycling the recovered ammonia into the ammonia supplied to the catalyst-containing reactor tubes.

5. A method according to claim 1, comprising compressing the PSA tail gas prior to supplying as the feed to the membrane separator.

6. A method according to claim 1, comprising compressing the hydrogen-rich permeate gas before the further processing in the PSA and/or the mixing into the hydrogen product gas.

7. A method according to claim 1, comprising:
compressing the PSA tail gas to produce compressed PSA tail gas;
cooling the compressed PSA tail gas by heat exchange against one or more cold fluids to condense ammonia in the compressed PSA tail gas; and
separating the condensed ammonia from the compressed PSA tail gas to produce ammonia-depleted PSA tail gas,
wherein the ammonia-depleted PSA tail gas is supplied as the feed to the membrane separator.

8. A method according to claim 7, wherein the one or more cold fluids comprise the pressurized liquid ammonia and the ammonia-depleted PSA tail gas.

9. A method according to claim 7, wherein the condensed ammonia is combined with the pressurized liquid ammonia.

10. A method according to claim 7, wherein the membrane separator comprises a first membrane separation unit and a second membrane separation unit in series, the method further comprising:
supplying the ammonia-depleted PSA tail gas to the first membrane separation unit to produce the hydrogen-rich permeate gas for further processing in the PSA and a nitrogen-enriched retentate gas comprising residual hydrogen gas; and
supplying the nitrogen-enriched retentate gas to the second membrane separation unit to discharge the nitrogen-rich retentate gas and produce a hydrogen-enriched permeate gas which is combined with the PSA tail gas.

11. A method as claimed in claim 1, wherein the membrane separator comprises a single membrane separation unit.

12. A method according to claim 1, further comprising expanding the nitrogen-rich retentate gas in a turbine to recover power.

13. A method according to claim 12, further comprising prior to expanding the nitrogen-rich retentate gas, heating the nitrogen-rich retentate gas by heat exchange with the one or more hot fluids.

14. A method according to claim 1, further comprising purifying the nitrogen-rich retentate gas to produce a nitrogen product.

15. Apparatus for producing hydrogen from ammonia, comprising:
a pump for pressurizing liquid ammonia;
at least one first heat exchanger in fluid communication with the pump for heating (and optionally vaporizing) the liquid ammonia from the pump by heat exchange with one or more hot fluids to produce heated ammonia;
catalyst-containing reactor tubes in fluid communication with the first heat exchanger(s), for cracking heated ammonia from the first heat exchanger(s) to produce a first cracked gas containing hydrogen gas and nitrogen gas;
a furnace in thermal communication with the catalyst-containing reactor tubes for combustion of a fuel to heat the catalyst-containing reactor tubes and to form a flue gas;
a cracked gas conduit for feeding cracked gas from the catalyst-containing reactor tubes to the at least one heat exchanger;
a flue gas conduit for feeding flue gas from the furnace to the at least one heat exchanger;
a PSA device in fluid communication with the catalyst-containing reactor tubes for purifying the cracked gas after passage through the at least one heat exchanger to produce a hydrogen product gas and a PSA tail gas;
a membrane separator in fluid communication with the PSA device for separating the PSA offgas, or a gas derived therefrom, to discharge a nitrogen-rich retentate gas and a hydrogen-rich permeate gas;
wherein the apparatus comprises a conduit for feeding the hydrogen-rich permeate gas to the PSA device for further processing and/or a conduit for combining hydrogen-rich permeate gas with the hydrogen product gas.

16. Apparatus according to claim 15 comprising an ammonia removal system upstream of the membrane separator.

17. Apparatus according to claim 16, wherein the ammonia removal system is located downstream of the PSA device for removing ammonia from the PSA tail gas.

18. Apparatus according to claim 16, wherein the ammonia removal system is located downstream of the at least one heat exchange and upstream of the PSA device for removing ammonia from the cracked gas.

19. Apparatus according to claim 16 comprising a PSA tail gas compressor downstream of the PSA device for compressing the PSA tail gas for the membrane separator 7.

20. Apparatus according to claim 16 comprising a hydrogen-rich permeate gas compressor downstream of the membrane separator for compressing the hydrogen-rich permeate gas for the PSA device and/or for combining with the hydrogen product gas.

21. Apparatus according to claim 16 comprising:
a PSA tail gas compressor in fluid communication with the PSA device for compressing PSA tail gas;
a heat exchanger in fluid communication with the PSA tail gas compressor for cooling compressed PSA tail gas by heat exchange against one or more cold fluids;
a phase separator in fluid communication with the heat exchanger for separating condensed ammonia from cooled compressed PSA tail gas to form ammonia-depleted PSA tail gas;
a conduit for supplying ammonia-depleted PSA tail gas from the phase separator to the membrane separator.

22. Apparatus according to claim 21 comprising a conduit for supplying the condensed ammonia to the pressurized liquid ammonia.

23. Apparatus according to claim 21, wherein the membrane separator comprises a first membrane separation unit and a second separation unit in series, said apparatus further comprising:
a conduit for supplying ammonia-depleted PSA tail gas from the phase separator to the first membrane separation unit;
a conduit for supplying the hydrogen-rich permeate gas from the first membrane separation unit to the PSA device for further processing;
a conduit for supplying a nitrogen-enriched retentate gas from the first membrane separation unit to the second membrane separation unit; and
a conduit for supplying another hydrogen-rich permeate gas from the second membrane unit to the PSA off gas.

24. Apparatus according to claim 16, wherein the membrane separator comprises a single membrane separation unit.

25. Apparatus according to claim 16 comprising a conduit for supplying nitrogen-rich retentate gas from the membrane separator to a vent.

26. Apparatus according to claim 25 comprising a turbine located downstream of the membrane separator for expanding nitrogen-rich permeate gas and recovering power.

27. Apparatus according to claim 26 comprising a heat exchanger located upstream of the turbine for heating nitrogen-rich permeate gas by heat exchange with one or more hot fluids.

28. Apparatus according to claim 16 comprising a nitrogen purification device in fluid communication with the membrane separator for purifying nitrogen-rich retentate gas to produce nitrogen gas product.
